(19) United States
(12) Patent Application Publication
(10) Pub. No.: US 2025/0179247 A1
(43) Pub. Date: Jun. 5, 2025

(54) BI-FUNCTIONALIZED ESTER-BASED COMPOUNDS FOR BREAKING CRUDE OIL EMULSIONS

(71) Applicants: Saudi Arabian Oil Company, Dhahran (SA); King Fahd University of Petroleum & Minerals, Dhahran (SA)

(72) Inventors: Manal Al Eid, Dhahran (SA); Muhammad Imran Ulhaq, Dhahran (SA); Ahmed T. Al-Gazi, Al Khobar (SA); Shaikh Asrof Ali, Dhahran (SA)

(21) Appl. No.: 18/529,867

(22) Filed: Dec. 5, 2023

(51) Int. Cl. C08G 65/332; B01D 17/04; C08G 65/08

(52) U.S. Cl. CPC C08G 65/3322; B01D 17/047; C08G 65/08

(57) ABSTRACT

This disclosure relates to bi-functionalized ester-based polymers that are useful as demulsifiers for water-in-oil emulsions. Also provided are methods of dewatering water-in-oil emulsions using compositions containing the bi-functionalized ester-based polymers.

### TECHNICAL FIELD

This document relates to bi-functionalized ester-based compounds, demulsifier compositions containing the compounds, and methods of breaking oil-in-water emulsions.

### BACKGROUND

The formation of water-in-oil emulsions is a common issue that receives sustained attention in the oilfield industry. It can occur at many stages during the production and processing of crude oil. The presence of water in crude oil can result in corrosion of the refinery equipment, thereby poisoning the catalyst in downstream processing facilities and increasing the pumping cost for transporting oil in the pipeline. It can also trip the equipment in the gas oil separation plant (GOSP), such as the dehydrator, causing high pressure drops in the flow line. Therefore, it is crucial to remove water from crude oil in order to meet crude specifications and reduce the related problems.

Finding efficient solutions to address the emulsion problem is a challenging process due to changing field conditions, especially when there is increasing water cut. Demulsifiers are commonly used in the oil and gas industry to mitigate the emulsion problem. Linear ethylene oxide/propylene oxide (EO/PO) copolymers have been widely used as an active component for enhancing the crude oil demulsification process. However, these copolymers suffer from several disadvantages, including low polydispersity, low functionality, and lack of flexibility. Additionally, increasing molecular weight leads to an increase in viscosity and a reduction in performance, thus limiting their effectiveness and use as demulsifiers, often times limiting their use to droppers only.

Thus, there is a need for a demulsifier that has high polydispersity, high functionality, and flexibility that can be used as a hybrid (dropper and treater).

### SUMMARY

Provided in the present disclosure is a compound of Formula (I):

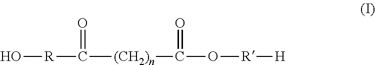

wherein:
   R is (PEO)ₓ(PPO)_{y}(PEO)_{z};
   R′ is (PEO)_{x′}(PPO)_{y′}(PEO)_{z′};
   PEO is polyethylene oxide having the formula:

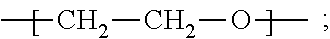

PPO is polypropylene oxide having the formula:

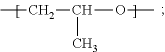

x and x′ are each independently an integer between 10-40;
y and y′ are each independently an integer between 50-80;
z and z′ are each independently an integer between 10-40; and n is an integer between 1 and 30.
In some embodiments, x and x′ are each independently an integer between 15 and 25. In some embodiments, x and x′ are each 20.

In some embodiments, y and y′ are each independently an integer between 65 and 75. In some embodiments, y and y′ are each 70.

In some embodiments, z and z′ are each independently an integer between 15 and 25. In some embodiments, z and z′ are each 20.

In some embodiments, n is an integer between 5 and 15. In some embodiments, n is 8.

In some embodiments, x and x′ are each independently an integer between 15 and 25; y and y′ are each independently an integer between 65 and 75; z and z′ are each independently an integer between 15 and 25; and n is an integer between 5 and 15.

In some embodiments, x and x′ are each 20; y and x′ are each 70; z and x′ are each 20; and n is 8.

Also provided in the present disclosure is a demulsifier composition containing the compound of Formula (I) and one or more solvents. In some embodiments, the solvent is an aromatic solvent, an alcohol, or combinations thereof. In some embodiments, the solvent is selected from xylene, methanol, or a combination thereof.

In some embodiments, the demulsifier composition further includes a linear tri-block polymer of Formula (II):

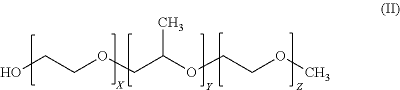

wherein:
   X is an integer between 10-40;
   Y is an integer between 50-80; and
   Z is an integer between 10-40.

In some embodiments, the ratio of the compound of Formula (I) to the compound of Formula (II) is 1:1.

In some embodiments, x=x′=X, y=y′=Y, and z=z′=Z.

Also provided in the present disclosure is a method of dewatering a water-in-oil emulsion, the method including adding a demulsifier composition containing the compound of Formula (I) to a water-in-oil emulsion and separating the water from the emulsion.

In some embodiments of the method, the composition further contains a linear tri-block copolymer of Formula (II):

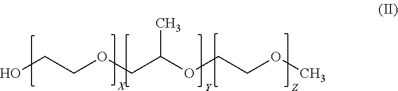

wherein:
   X is an integer between 10-40;
   Y is an integer between 50-80; and
   Z is an integer between 10-40.

In some embodiments of the method, the water-in-oil emulsion is a crude oil emulsion. In some embodiments, about 10% to about 50% of the total volume of water is separated from the emulsion. In some embodiments, about 10% to about 50% of the total volume of water is separated from the emulsion after about 60 minutes.

Also provided in the present disclosure is a method of treating produced petroleum containing an emulsion, the method including contacting the produced petroleum containing the emulsion with a demulsifier composition to reduce or eliminate the emulsion, the demulsifier composition containing a compound of Formula (I). In some embodiments, about 10% to about 50% of the total volume of water is separated from the emulsion.

### DESCRIPTION OF DRAWINGS

FIG. 1A shows the ¹H NMR spectra of PEO-b-PPO-b-PEO (Mn 5,800 g/mol) in CDCl₃.

FIG. 1B shows the ¹H NMR spectra of an exemplary bi-functionalized ester in CDCl₃.

FIG. 2 is a bar graph showing performance of different demulsifier formulations containing an exemplary bi-functionalized ester.

FIG. 3 depicts the results of a bottle test showing separated water after 60 minutes at 70° F.

### DETAILED DESCRIPTION

Due to a number of factors involved in the production process, oil and water mix, creating an emulsion. This is undesirable, because when crude oil is refined, the oil should be as dry as possible as water can damage the refinery, induce corrosion, and reduce the efficiency of the crude oil distillation process. Provided in the present disclosure are bi-functionalized ester-based polymers that can be used as demulsifiers to break crude oil-water emulsions. In some embodiments, the demulsifiers exhibit improved water separation performance as compared to known demulsifiers, in particular, linear EO/PO polymers that do not contain the ester functionality. In some embodiments, the demulsifiers of the present disclosure are more efficient in dewatering wet crude oil emulsions than known demulsifiers. For example, the demulsifiers allow for dewatering of larger volumes of water than known demulsifiers.

This disclosure provides a bi-functionalized ester-based polymer that contains triblock alkylene oxide groups, as an efficient dehydrating agent for crude oil emulsion. The general formula of the invention is “[HO—[(R)]—CO—(CH₂)ₙ—CO—[(R′)]—H],” where R═[(EO)_{X}—(PO)_{Y}-(EO)_{Z}], R′═[(EO)_{X′}—(PO)_{Y′}-(EO)_{Z′}] and the x, x′, y, y′, z, and z′ are the composition fractions of the respective monomers in the polymer. The resulting polymer is as an active component in demulsifier products and can increase the performance by about 20% in comparison to their linear analogs. The present disclosure provides a method to mitigate water/oil emulsion using the environmentally friendly bi-functionalized ester-based polymers as demulsifiers.

The addition of the bi-functionalized demulsifying agents of the present disclosure to petroleum emulsions allows for absorption at the interfaces of droplets, thus promoting coalescence. The compounds of the present disclosure contain combinations of building blocks of ethylene oxide (EO) and propylene oxide (PO). A variety of functional group such as alkyl-phenols and ethoxylated amines, can be added to the polymer backbone to improve the functionality of final product. The structure of demulsifiers plays a critical role in the demulsification process. The polymers of the present disclosure have several advantageous properties as compared to the corresponding linear polymer that is not bi-functionalized via an ester linkage, including high polydispersity, increased hydrophilicity, increased functionality, better performance, and increased flexibility. The compounds of the present disclosure are able to be used in a hybrid capacity, not only as dropper, but as treater as well. In comparison, many linear tri-block copolymers are only utilized as droppers.

Without wishing to be bound by any particular theory, it is believed that the increased flexibility and hydrophilicity of the demulsifiers of the present disclosure results in unexpected improvement in water separation.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

In this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used herein can allow for a degree of variability in a value or range, for example, within 10%, within 5%, or within 1% of a stated value or of a stated limit of a range.

A “demulsifier,” also known as an “emulsion breaker,” is a chemical that is used to separate crude oil from water. Demulsifiers are chemicals designed to neutralize the stabilizing effect of emulsifying agents. Demulsifiers are surface-active compounds that, when added to the emulsion, migrate to the oil/water interface, rupture or weaken the rigid film, and enhance water droplet coalescence. The process by which oil and water emulsions are separated is known as “demulsification” and it can be done in a variety of ways, including addition of a chemical demulsifier to the emulsion. In some embodiments, the demulsifier is a polymer, referred to herein as a “demulsifying polymer.”

“Dewatering,” as used herein, is the process of removing or separating water from crude oil. In some embodiments, the water is removed or separated from an emulsion that is a water-in-oil emulsion.

As used in this disclosure, the term “subterranean formation” can refer to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region that is in fluid contact with the wellbore. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground that is in fluid contact with liquid or gaseous petroleum materials or water. In some embodiments, a subterranean formation is an oil well.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Demulsifier Compositions

Provided in this disclosure is a bi-functionalized ester-based polymer and demulsifier compositions containing the polymer. The polymer and compositions containing the polymer can be used to dewater wet crude oil emulsions. In some embodiments, compositions containing the is polymer of the present disclosure are more efficient at dewatering wet crude oil emulsions as compared to compositions that do not contain the demulsifying polymer of the present disclosure, but contain the corresponding linear tri-block copolymer.

### Bi-Functionalized Ester-Based Polymers

Provided in the present disclosure are bi-functionalized ester-based polymers. The polymers are constituted of a alkylene diester backbone bonded to a tri-block copolymer made up of polypropylene oxide (PPO) and polyethylene oxide (PEO), where each ester is bonded to the tri-block copolymer.

In some embodiments, the polymer is a compound of Formula (I):

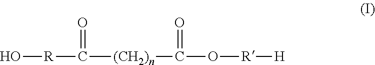

wherein:
   R is (PEO)ₓ(PPO)_{y}(PEO)_{z};
   R′ is (PEO)_{x′}(PPO)_{y′}(PEO)_{z′};
   PEO is polyethylene oxide having the formula:

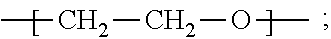

PPO is polypropylene oxide having the formula:

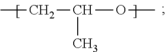

x and x′ are each independently an integer between 10-40;
y and y′ are each independently an integer between 50-80;
z and z′ are each independently an integer between 10-40; and
n is an integer between 1 and 30.

In some embodiments, x and x′ are each independently an integer between 10 and 40, such as between 10 and 35, 10 and 30, 10 and 25, 10 and 20, 10 and 15, 15 and 40, 15 and 35, 15 and 30, 15 and 25, 15 and 20, 20 and 40, 20 and 35, 20 and 30, 20 and 25, 25 and 40, 25 and 35, 25 and 30, 30 and 40, 30 and 35, or 35 and 40. In some embodiments, x is 10, 15, 20, 25, 30, 35, or 40. In some embodiments, x is an integer between 15 and 25. In some embodiments, x is 20. In some embodiments, x′ is 10, 15, 20, 25, 30, 35, or 40. In some embodiments, x′ is an integer between 15 and 25. In some embodiments, x′ is 20. In some embodiments, x and x′ are the same. In some embodiments, x and x′ are different.

In some embodiments, y and y′ are each independently an integer between 50 and 80, such as between 50 and 75, 50 and 70, 50 and 65, 50 and 60, 50 and 55, 60 and 80, 60 and 75, 60 and 70, 60 and 65, 65 and 80, 65 and 75, 65 and 70, 70 and 80, 70 and 75, or 75 and 80. In some embodiments, y is 50, 55, 60, 65, 70, 75, or 80. In some embodiments, y is an integer between 65 and 75. In some embodiments, y is 70. In some embodiments, y′ is 50, 55, 60, 65, 70, 75, or 80. In some embodiments, y′ is an integer between 65 and 75. In some embodiments, y′ is 70. In some embodiments, y and y′ are the same. In some embodiments, y and y′ are different.

In some embodiments, z and z′ are each independently an integer between 10 and 40, such as between 10 and 35, 10 and 30, 10 and 25, 10 and 20, 10 and 15, 15 and 40, 15 and 35, 15 and 30, 15 and 25, 15 and 20, 20 and 40, 20 and 35, 20 and 30, 20 and 25, 25 and 40, 25 and 35, 25 and 30, 30 and 40, 30 and 35, or 35 and 40. In some embodiments, z is 10, 15, 20, 25, 30, 35, or 40. In some embodiments, z is an integer between 15 and 25. In some embodiments, z is 20. In some embodiments, z′ is 10, 15, 20, 25, 30, 35, or 40. In some embodiments, z′ is an integer between 15 and 25. In some embodiments, z′ is 20. In some embodiments, z and z′ are the same. In some embodiments, z and z′ are different.

In some embodiments, x and z are the same. In some embodiments, x and z are different. In some embodiments, x is an integer between 15 and 25 and z is an integer between 15 and 25. In some embodiments, x is 20 and z is 20.

In some embodiments, x′ and z′ are the same. In some embodiments, x′ and z′ are different. In some embodiments, x′ is an integer between 15 and 25 and z′ is an integer between 15 and 25. In some embodiments, x′ is 20 and z′ is 20.

In some embodiments, n is an integer between 1 and 30, such as between 1 and 25, 1 and 20, 1 and 15, 1 and 10, 1 and 5, 5 and 30, 5 and 25, 5 and 20, 5 and 15, 5 and 10, 10 and 30, 10, and 25, 10 and 20, 10 and 15, 15 and 30, 15 and 25, 15 and 20, 20 and 30, 20 and 25, or 25 and 30. In some embodiments, n is 1, 5, 8, 10, 15, 20, 25, or 30. In some embodiments, n is an integer between 5 and 15. In some embodiments, n is 8.

In some embodiments, x is an integer between 15 and 25; y is an integer between 65 and 75; z is an integer between 15 and 25; and n is an integer between 5 and 15. In some embodiments, x is 20; y is 70; z is 20; and n is 8.

In some embodiments, x′ is an integer between 15 and 25; y′ is an integer between 65 and 75; z′ is an integer between 15 and 25; and n is an integer between 5 and 15. In some embodiments, x′ is 20; y′ is 70; z′ is 20; and n is 8.

In some embodiments, x and x′ are each an integer between 15 and 25; y and y′ are each an integer between 65 and 75; z and z′ are each an integer between 15 and 25; and n is an integer between 5 and 15. In some embodiments, x and x′ are 20; y and y′ are 70; z and z′ are 20; and n is 8.

### Demulsifier Composition

Provided in the present disclosure is a demulsifier composition that contains the polymer of Formula (I) as described in the present disclosure. In some embodiments, the demulsifier composition contains, in addition to the demulsifying polymer of Formula (I), one or more of a solvent, a linear tri-block copolymer, or combinations thereof.

In some embodiments, the demulsifier composition contains about 10 wt % to about 70 wt % of the polymer of Formula (I) as described in the present disclosure, such as about 10 wt % to about 65 wt %, about 10 wt % to about 60 wt %, about 10 wt % to about 55 wt %, about 10 wt % to about 50 wt %, about 10 wt % to about 45 wt %, about 10 wt % to about 40 wt %, about 10 wt % to about 35 wt %, about 10 wt % to about 30 wt %, about 10 wt % to about 25 wt %, about 10 wt % to about 20 wt %, about 10 wt % to about 15 wt %, about 15 wt % to about 70 wt %, about 15 wt % to about 65 wt %, about 15 wt % to about 60 wt %, about 15 wt % to about 55 wt %, about 15 wt % to about 50 wt %, about 15 wt % to about 45 wt %, about 15 wt % to about 40 wt %, about 15 wt % to about 35 wt %, about 15 wt % to about 30 wt %, about 15 wt % to about 25 wt %, about 15 wt % to about 20 wt %, about 20 wt % to about 70 wt %, about 20 wt % to about 65 wt %, about 20 wt % to about 60 wt %, about 20 wt % to about 55 wt %, about 20 wt % to about 50 wt %, about 20 wt % to about 45 wt %, about 20 wt % to about 40 wt %, about 20 wt % to about 35 wt %, about 20 wt % to about 30 wt %, about 20 wt % to about 25 wt %, about 25 wt % to about 70 wt %, about 25 wt % to about 65 wt %, about 25 wt % to about 60 wt %, about 25 wt % to about 55 wt %, about 25 wt % to about 50 wt %, about 25 wt % to about 45 wt %, about 25 wt % to about 40 wt %, about 25 wt % to about 35 wt %, about 25 wt % to about 30 wt %, about 30 wt % to about 70 wt %, about 30 wt % to about 65 wt %, about 30 wt % to about 60 wt %, about 30 wt % to about 55 wt %, about 30 wt % to about 50 wt %, about 30 wt % to about 45 wt %, about 30 wt % to about 40 wt %, about 30 wt % to about 35 wt %, about 35 wt % to about 70 wt %, about 35 wt % to about 65 wt %, about 35 wt % to about 60 wt %, about 35 wt % to about 55 wt %, about 35 wt % to about 50 wt %, about 35 wt % to about 45 wt %, about 35 wt % to about 40 wt %, about 40 wt % to about 70 wt %, about 40 wt % to about 65 wt %, about 40 wt % to about 60 wt %, about 40 wt % to about 55 wt %, about 40 wt % to about 50 wt %, about 40 wt % to about 45 wt %, about 45 wt % to about 70 wt %, about 45 wt % to about 65 wt %, about 45 wt % to about 60 wt %, about 45 wt % to about 55 wt %, about 45 wt % to about 50 wt %, about 50 wt % to about 70 wt %, about 50 wt % to about 65 wt %, about 50 wt % to about 60 wt %, about 50 wt % to about 55 wt %, about 55 wt % to about 70 wt %, about 55 wt % to about 65 wt %, about 55 wt % to about 60 wt %, about 60 wt % to about 70 wt %, about 60 wt % to about 65 wt %, about 65 wt % to about 70 wt %, or about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, or about 70 wt %.

In some embodiments, the demulsifier composition contains one or more solvents. Examples of suitable solvents include, but are not limited to, alcohols, alkylene glycols, polyalkylene glycols, xylenes, toluene, aromatics, and combinations thereof. In some embodiments, the solvent is an aromatic solvent, an alcohol, or a combination thereof. In some embodiments, the aromatic solvent is naphtha. In some embodiments, the solvent contains an alcohol. In some embodiments, the solvent contains isopropanol. In some embodiments, the solvent contains methanol. In some embodiments, the solvent contains xylene. In some embodiments, the solvent contains xylene and an alcohol. In some embodiments, the solvent contains xylene and methanol.

In some embodiments, the solvent is a mixture of xylene and an alcohol. In some embodiments, the solvent is a mixture of xylene and methanol. In some embodiments, the amount of xylene is about 75 wt % to about 99 wt % of the total amount of solvent, such as about 75 wt % to about 95 wt %, about 75 wt % to about 90 wt %, about 75 wt % to about 85 wt %, about 75 wt % to about 80 wt %, about 80 wt % to about 99 wt %, about 80 wt % to about 95 wt %, about 80 wt % to about 90 wt %, about 80 wt % to about 85 wt %, about 85 wt % to about 99 wt %, about 85 wt % to about 95 wt %, about 85 wt % to about 90 wt %, about 90 wt % to about 99 wt %, about 90 wt % to about 95 wt %, about 95 wt % to about 99 wt %, or about 75 wt %, about 80 wt %, about 85 wt %, about 90 wt %, or about 99 wt %. In some embodiments, the amount of xylene is about 95 wt % of the total amount of solvent. In some embodiments, the amount of alcohol is about 1 wt % to about 25 wt % of the total amount of solvent, such as about 1 wt % to about 20 wt %, about 1 wt % to about 15 wt %, about 1 wt % to about 10 wt %, about 1 wt % to about 5 wt %, about 5 wt % to about 25 wt %, about 5 wt % to about 20 wt %, about 5 wt % to about 15 wt %, about 5 wt % to about 10 wt %, about 10 wt % to about 25 wt %, about 10 wt % to about 20 wt %, about 10 wt % to about 15 wt %, about 15 wt % to about 25 wt %, about 15 wt % to about 20 wt %, about 20 wt % to about 25 wt %, or about 1 wt %, about 5 wt %, about 10 wt %, about 15 wt %, about 20 wt %, or about 25 wt %. In some embodiments, the amount of alcohol is about 5 wt % of the total amount of solvent. In some embodiments, the alcohol is methanol.

In some embodiments, the demulsifier composition further contains a linear tri-block polymer of Formula (II):

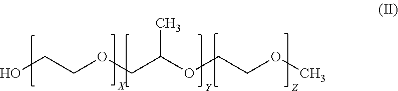

wherein:
   X is an integer between 10-30;
   Y is an integer between 60-80; and
   Z is an integer between 10-30.

In some embodiments, the ratio of the compound of Formula (I) to the compound of Formula (II) is about 10:1 to about 1:10, such as about 5:1 to about 1:5, about 3:1 to about 1:3, about 2:1 to about 1:2, or about 10:1, 5:1, 3:1, 2:1, 1:1, 1:2, 1:3, 1:5, or 1:10. In some embodiments, the ratio of the compound of Formula (I) to the compound of Formula (II) is 1:1. In some embodiments, x=x′=X, y=y′=Y, and z=z′=Z.

### Methods of Using the Demulsifier Composition Containing the Polymer

The demulsifying polymers of the present disclosure have a greater activity towards dewatering wet crude oil emulsions than the corresponding linear tri-block copolymer. It has surprisingly been found that bonding two linear tri-block copolymers via a diester linkage significantly increases the water separation activity of the polymers of the present disclosure. In some embodiments, the polymers and demulsifier compositions containing the polymers of the present disclosure are more effective at separating water from a water-in-oil emulsion than the corresponding linear tri-block copolymer. In some embodiments, the polymers of the present disclosure and demulsifier compositions that contain the polymers of the present disclosure are used for water-in-oil emulsions in a subterranean formation for drilling operations. In some embodiments, the polymers of the present disclosure and demulsifier compositions that contain the polymers of the present disclosure are used for oilfield production at gas-oil separation plants. In some embodiments, the polymers of the present disclosure and demulsifier compositions that contain the polymers of the present disclosure are used for desalting at refineries. Thus, provided in the present disclosure are methods of using the polymers of the present disclosure and demulsifier compositions that contain the polymers of the present disclosure for such applications.

The polymers of the present disclosure can be used alone or in blends with other demulsifiers or emulsion breaker materials, including, but not limited to, other alkoxylated alkylphenol-formaldehyde polymers, alkoxylated polyvinyl esters, alkoxylated phenols, alkoxylated polyalcohols (also known as polyols), polyethylene or polypropylene glycols and derivatives, and arylsulfonates. The polymers of the present disclosure can also be used in combination with corrosion inhibitors, viscosity reducers, desalting polymers, and other oilfield chemicals used in crude oil production, refining, and chemical processing.

In some embodiments, the polymer of the present disclosure is used to resolve emulsions encountered in crude oil production. In some embodiments, the polymer of the present disclosure or composition containing the polymer of the present disclosure is introduced into the crude oil emulsion by injecting prior entering the oil production facility, by injecting into the crude oil before the desalter, or by injecting into the crude oil process stream at a point between the oil production and the final oil storage tank. The demulsifier composition can be injected continuously or in batch fashion. In some embodiments, the injection is accomplished using electric or gas pumps.

After injection, in some embodiments the treated crude oil emulsion is allowed to stand in a quiescent state until the desired separation into distinct layers of water and oil results. Once separation into distinct layers of water and oil has been effected, any means known to those of skill in the art can be utilized for withdrawing the free water and separating crude oil.

Also provided in the present disclosure is a method of dewatering a water-in-oil emulsion. In some embodiments, the method includes adding a demulsifier composition comprising the polymer of Formula (I) as described in the present disclosure to a water-in-oil emulsion. In some embodiments, the method involves separating the water from the emulsion. In some embodiments, the water-in-oil emulsion is a crude oil emulsion. In some embodiments, the crude oil emulsion is a refinery desalting emulsion. In some embodiments, the crude oil emulsion is a crude oil production emulsion. In some embodiments, the composition further contains the compound of Formula (II).

In some embodiments of the methods of the present disclosure, the amount of demulsifier composition used to treat the emulsions is about 100 ppm to about 300 ppm, such as about 100 ppm to about 250 ppm, about 100 ppm to about 200 ppm, about 100 ppm to about 150 ppm, about 150 ppm to about 300 ppm, about 150 ppm to about 250 ppm, about 150 ppm to about 200 ppm, about 200 ppm to about 300 ppm, about 200 ppm to about 250 ppm, about 250 ppm to about 300 ppm, or about 100 ppm, about 150 ppm, about 200 ppm, about 250 ppm, or about 300 ppm. In some embodiments, the amount of demulsifier composition is about 200 ppm.

In the methods of the present disclosure, the dewatering takes place at temperatures of about 70° F. to about 150° F., such as about 70° F. to about 125° F., about 70° F. to about 100° F., about 75° F. to about 150° F., about 75° F. to about 125° F., about 75° F. to about 100° F., about 100° F. to about 150° F., about 100° F. to about 125° F., about 125° F. to about 150° F., or about 70° F., about 75° F., about 80° F., about 85° F., about 90° F., about 95° F., about 100° F., about 105° F., about 110° F., about 115° F., about 120° F., about 125° F., about 130° F., about 135° F., about 140° F., about 145° F., or about 150° F. In some embodiments, the dewatering takes place at temperatures of about 70° F. to about 75° F. In some embodiments, the dewatering takes place at temperatures of about 70° F. In some embodiments, the dewatering takes place at temperatures of about 75° F.

Also provided in the present disclosure is a method of treating produced petroleum that contains an emulsion. In some embodiments, the method includes contacting the produced petroleum that contains the emulsion with a demulsifier composition to reduce or eliminate the emulsion. In some embodiments, the demulsifier composition contains a compound of Formula (I) as described in the present disclosure. In some embodiments, the demulsifier composition contains a compound of Formula (II) in addition to the compound of Formula (I).

The amount of polymer that is used depends on the particular crude oil emulsion being treated. In some embodiments, the optimum dosage is determined during a field test. In some embodiments, bottle tests, such as described in the present disclosure, are conducted in order to determine the optimum formulation, for example, the optimum formulation of demulsifying polymer, solvent, and clarifier. The desired amount of polymer can vary depending on the specific characteristics of the emulsion. In some embodiments, the amount of polymer is between about 100 ppm and about 300 ppm.

In some embodiments of the methods of the present disclosure, about 10% to about 50% of the total volume of water in the emulsion is separated from the emulsion, such as at least about 20%, at least about 25%, at least about 30%, at least about 35%, at least about 40%, or more. In some embodiments, about 10% to about 50% of the total volume water is separated from the emulsion after about 60 minutes.

### EXAMPLES

### Example 1—Preparation of Bi-Functionalized Ester

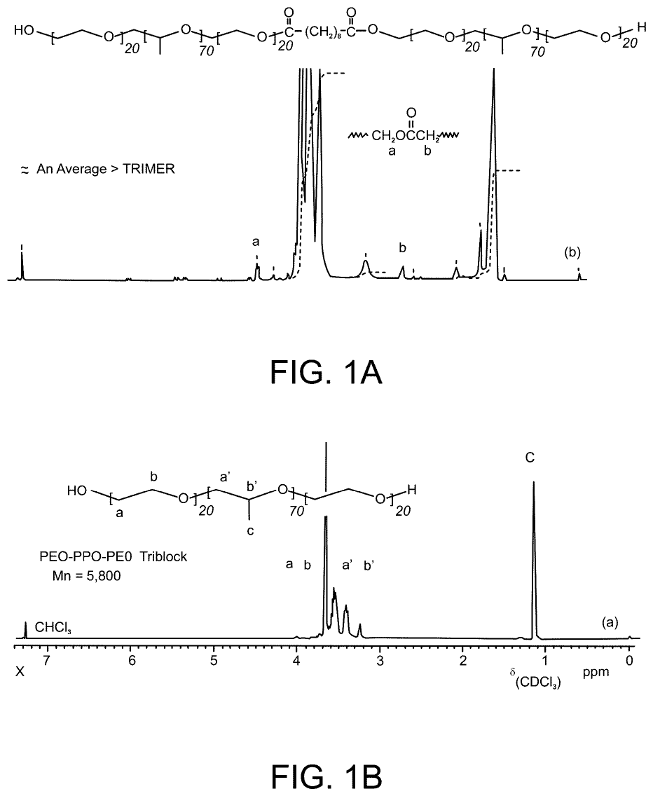

The condensation polymerization of PEO-b-PPO-b-PEO (Mn 5,800 g/mol) 1 with sebacic acid was carried out as follows and as shown in Scheme 1. A solution of 1 (7.58 g, 1.31 mmol), sebacic acid [HO₂C(CH₂)₈CO₂H](183 mg, 0.905 mmol) and p-toluene sulfonic acid (200 mg) in toluene (50 mL) was refluxed in a Dean-Stark apparatus for 48 h. After removal of the solvent, the residue was dried under vacuum at 60° C. to obtain compound 2 (5.0 g, ≈100%) as a colorless liquid. The ¹H-NMR spectra of the PEO-PPO-PEO triblock 1 is shown in FIG. 1A and the ¹H-NMR spectra of compound 2 is shown in FIG. 1B.

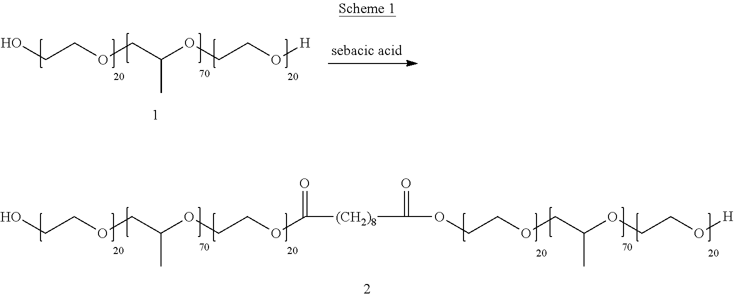

### Example 2—Performance Test

Four different demulsifier samples (A-D) were prepared as shown in Table 1. Sample A was a control. Samples B-D were prepared in an organic solvent system (10 mL xylene+0.5 mL methanol) and contained PEO-b-PPO-b-PEO (Mn 5,800 g/mol) 1 (Sample B), bi-functionalized ester 2 as prepared in Example 1 (Sample C), or a 1:1 mixture of 1 and 2 (Sample D).

TABLE 1

| Demulsifier sample | Components |
|---|---|
| A | Control (field emulsion only) |
| B | PEO-b-PPO-b-PEO (Mn 5,800 g/mol) 1 |
| C | Bi-functionalized ester 2 |
| D | 1 and 2 (1:1) |

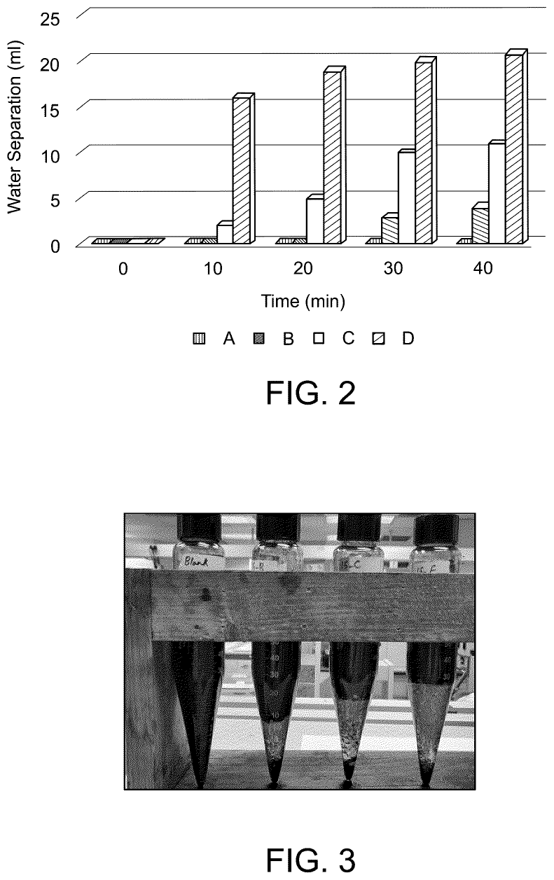

A field emulsion sample was collected from a production header and had 50% water cut. 200 ppm of demulsifier samples A-D were added to four different 100 mL graduated settling bottle/tube containing 70.0 mL of the emulsion and mixed by hand/shaken for 1-5 min. The bottles/tubes with emulsion and demulsifier were placed vertically at room temperature (75° F.). The volume (mL) of water separated was measured with time and is shown in Table 2 and FIG. 2.

TABLE 2
Volume of separated water at 75° F. over time

| | Elapsed time (min) | | | | | | Total water | |
|---|---|---|---|---|---|---|---|---|
| | 10 | 20 | 30 | 40 | 50 | 60 | volume in | Efficiency |
| Sample | Volume of water separated (mL) | | | | | | sample (mL) | (%) |
| A | 0 | 0 | 0 | 0 | 0 | 0 | 0 | 0 |
| B | 0 | 0 | 3 | 4 | 6 | 9 | 70 | 13 |
| C | 2 | 5 | 10 | 11 | 13 | 18 | 70 | 26 |
| D | 16 | 19 | 20 | 21 | 23 | 29 | 70 | 41 |

### EMBODIMENTS

Embodiment 1. A compound of Formula (I):

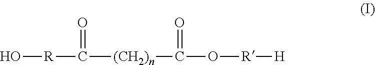

wherein:
   R is (PEO)ₓ(PPO)_{y}(PEO)_{z};
   R′ is (PEO)_{x′}(PPO)_{y′}(PEO)_{z′};
   PEO is polyethylene oxide having the formula:

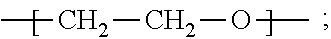

PPO is polypropylene oxide having the formula:

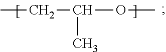

x and x′ are each independently an integer between 10-40;
y and y′ are each independently an integer between 50-80;
z and z′ are each independently an integer between 10-40; and
n is an integer between 1 and 30.
   Embodiment 2. The compound of embodiment 1, wherein x and x′ are each independently an integer between 15 and 25.
   Embodiment 3. The compound of embodiment 1 or 2, wherein x and x′ are each 20.
   Embodiment 4. The compound of any one of embodiments 1-3, wherein y and y′ are each independently an integer between 65 and 75.
   Embodiment 5. The compound of any one of embodiments 1-4, wherein y and y′ are each 70.
   Embodiment 6. The compound of any one of embodiments 1-5, wherein z and z′ are each independently an integer between 15 and 25.
   Embodiment 7. The compound of any one of embodiments 1-6, wherein z and z′ are each 20.
   Embodiment 8. The compound of any one of embodiments 1-7, wherein n is an integer between 5 and 15.
   Embodiment 9. The compound of any one of embodiments 1-8, wherein n is 8.
   Embodiment 10. The compound of any one of embodiments 1-9, wherein:
x and x′ are each independently an integer between 15 and 25;
y and y′ are each independently an integer between 65 and 75;
z and z′ are each independently an integer between 15 and 25; and
n is an integer between 5 and 15.
   Embodiment 11. The compound of any one of embodiments 1-10, wherein:
x and x′ are each 20;
y and y′ are each 70;
z and z′ are each 20; and
n is 8.
   Embodiment 12. A demulsifier composition comprising the compound of Formula (I) according to any one of embodiments 1-11 and one or more solvents.
   Embodiment 13. The demulsifier composition of embodiment 12, wherein the solvent is an aromatic solvent, an alcohol, or combinations thereof.
   Embodiment 14. The demulsifier composition of embodiment 12 or 13, wherein the solvent is selected from xylene, methanol, or a combination thereof.
   Embodiment 15. The demulsifier composition of any one of embodiments 12-14, further comprising a linear tri-block polymer of Formula (II):

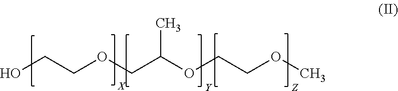

wherein:
   X is an integer between 10-40;
   Y is an integer between 50-80; and
   Z is an integer between 10-40.
      Embodiment 16. The demulsifier composition of embodiment 15, wherein the ratio of the compound of Formula (I) to the compound of Formula (II) is 1:1.
      Embodiment 17. The demulsifier composition of embodiment 15 or 16, wherein x=x′=X, y=y′=Y, and z=z′=Z.
      Embodiment 18. A method of dewatering a water-in-oil emulsion, comprising adding a demulsifier composition comprising the compound of Formula (I) according to any one of embodiments 1-11 to a water-in-oil emulsion and separating the water from the emulsion.
      Embodiment 19. The method of embodiment 18, wherein the composition further comprises a linear tri-block copolymer of Formula (II):

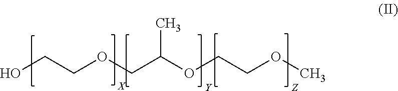

wherein:
   X is an integer between 10-40;
   Y is an integer between 50-80; and
   Z is an integer between 10-40.
      Embodiment 20. The method of embodiment 18 or 19, wherein the water-in-oil emulsion is a crude oil emulsion.
      Embodiment 21. The method of any one of embodiments 18-20, wherein about 10% to about 50% of the total volume of water is separated from the emulsion.
      Embodiment 22. The method of any one of embodiments 18-21, wherein about 10% to about 50% of the total volume of water is separated from the emulsion after about 60 minutes.
      Embodiment 23. A method of treating produced petroleum comprising an emulsion, the method comprising contacting the produced petroleum comprising the emulsion with a demulsifier composition to reduce or eliminate the emulsion, the demulsifier composition comprising a compound of Formula (I) according to any one of embodiments 1-11.
      Embodiment 24. The method of embodiment 23, wherein about 10% to about 50% of the total volume of water is separated from the emulsion.

What is claimed is:

1. A compound of Formula (I): 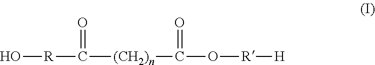
wherein:
R is (PEO)ₓ(PPO)_{y}(PEO)_{z};
R′ is (PEO)_{x′}(PPO)_{y′}(PEO)_{z′};
PEO is polyethylene oxide having the formula: 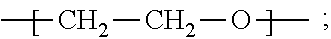
PPO is polypropylene oxide having the formula: 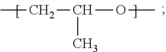
x and x′ are each independently an integer between 10-40;
y and y′ are each independently an integer between 50-80;
z and z′ are each independently an integer between 10-40; and
n is an integer between 1 and 30.

2. The compound of claim 1, wherein x and x′ are each independently an integer between 15 and 25.

3. The compound of claim 1, wherein x and x′ are each 20.

4. The compound of claim 1, wherein y and y′ are each independently an integer between 65 and 75.

5. The compound of claim 1, wherein y and y′ are each 70.

6. The compound of claim 1, wherein z and z′ are each independently an integer between 15 and 25.

7. The compound of claim 1, wherein z and z′ are each 20.

8. The compound of claim 1, wherein n is an integer between 5 and 15.

9. The compound of claim 1, wherein n is 8.

10. The compound of claim 1, wherein:
x and x′ are each independently an integer between 15 and 25;
y and y′ are each independently an integer between 65 and 75;
z and z′ are each independently an integer between 15 and 25; and
n is an integer between 5 and 15.

11. The compound of claim 1, wherein:
x and x′ are each 20;
y and x′ are each 70;
z and x′ are each 20; and
n is 8.

12. A demulsifier composition comprising the compound of Formula (I) according to claim 1 and one or more solvents.

13. The demulsifier composition of claim 12, wherein the solvent is an aromatic solvent, an alcohol, or combinations thereof.

14. The demulsifier composition of claim 12, wherein the solvent is selected from xylene, methanol, or a combination thereof.

15. The demulsifier composition of claim 12, further comprising a linear tri-block polymer of Formula (II): 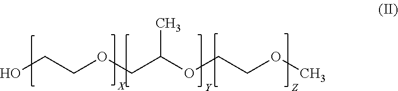
wherein:
X is an integer between 10-40;
Y is an integer between 50-80; and
Z is an integer between 10-40.

16. The demulsifier composition of claim 15, wherein the ratio of the compound of Formula (I) to the compound of Formula (II) is 1:1.

17. The demulsifier composition of claim 15, wherein x=x′=X, y=y′=Y, and z=z′=Z.

18. A method of dewatering a water-in-oil emulsion, comprising adding a demulsifier composition comprising the compound of Formula (I) according to claim 1 to a water-in-oil emulsion and separating the water from the emulsion.

19. The method of claim 18, wherein the composition further comprises a linear tri-block copolymer of Formula (II): 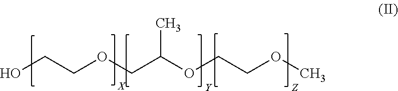
wherein:
X is an integer between 10-40;
Y is an integer between 50-80; and
Z is an integer between 10-40.

20. The method of claim 18, wherein the water-in-oil emulsion is a crude oil emulsion.

21. The method of claim 18, wherein about 10% to about 50% of the total volume of water is separated from the emulsion.

22. The method of claim 18, wherein about 10% to about 50% of the total volume of water is separated from the emulsion after about 60 minutes.

23. A method of treating produced petroleum comprising an emulsion, the method comprising contacting the produced petroleum comprising the emulsion with a demulsifier composition to reduce or eliminate the emulsion, the demulsifier composition comprising a compound of Formula (I) according to claim 1.

24. The method of claim 23, wherein about 10% to about 50% of the total volume of water is separated from the emulsion.
